(19) United States
(12) Patent Application Publication
(10) Pub. No.: US 2017/0286927 A1
(43) Pub. Date: Oct. 5, 2017

(54) METHOD AND DEVICE FOR ONLINE PAYMENT

(71) Applicant: Beijing Xiaomi Mobile Software Co., Ltd., Beijing (CN)

(72) Inventors: Ming LIU, Beijing (CN); Minghao LI, Beijing (CN); Liangxiong WU, Beijing (CN)

(21) Appl. No.: 15/422,699

(22) Filed: Feb. 2, 2017

(30) Foreign Application Priority Data
Mar. 29, 2016 (CN) 201610186624.6

(51) Int. Cl. G06Q 20/10; G06Q 20/40

(52) U.S. Cl. CPC G06Q 20/102; G06Q 20/401

(57) ABSTRACT

A method for online payment includes: setting a safe payment system account that enables a safe payment environment, wherein applications running and installed under the safe payment system account pass safety verification; and logging into the safe payment system account, and performing payment operations under the safe payment system account.

### CROSS-REFERENCE TO RELATED APPLICATIONS

The present application is based upon and claims priority to Chinese Patent Application No. 201610186624.6, filed Mar. 29, 2016, the entire contents of which are incorporated herein by reference.

### TECHNICAL FIELD

The present disclosure generally relates to network technology, and more particularly, to a method and device for conducting an online payment.

### BACKGROUND

With the continuous development of network technologies, various smart terminals provide more and more services for people via networks, which bring great conveniences to people's daily life. For example, people can use mobile terminals to conduct operations such as online payment and money transfer as long as the mobile terminals are connected to networks. In this way, people do not need to carry large amounts of cash, and avoid troubles resulting from change, i.e., the money received when paying for something with more money than it costs. Thus, the online payment has become a preferred method for more and more users.

At present, online payment can be realized as follows. When a smart terminal is currently connected to a network and when the smart terminal detects a trigger operation for making a payment in an application client having an online payment function, the smart terminal obtains the payment data, which includes at least account information of the payment receiver and the amount to be paid, and sends the payment data to a server corresponding to the application client. After information indicating successful payment returned from the server is received, the online payment is completed. The network connected to the smart terminal can be an operator network or a Wireless Fidelity (WiFi) network.

Because various smart terminals reside in relatively complex network environments, for example, unscrupulous individuals may steal users' personal information by using falsified networks when a user is paying online, it is hard to prevent all sorts of potential payment risks during online payment, which may cause great damage to users' interests.

### SUMMARY

According to one aspect of the present disclosure, there is provided a method for online payment. The method includes: setting a safe payment system account that enables a safe payment environment, wherein applications running and installed under the safe payment system account pass safety verification; and logging into the safe payment system account, and performing payment operations under the safe payment system account.

According to another aspect of the present disclosure, there is provided a device for online payment. The device includes a processor and a memory for storing instructions executable by the processor. The processor is configured to: set a safe payment system account that enables a safe payment environment, wherein applications running and installed under the safe payment system account pass safety verification; and log into the safe payment system account, and perform payment operations under the safe payment system account.

According to another aspect of the present disclosure, there is provided a non-transitory computer-readable storage medium having stored therein instructions that, when executed by a processor of a smart terminal, causes the smart terminal to perform a method for conducting an online payment, the method including: setting a safe payment system account that enables a safe payment environment, wherein applications running and installed under the safe payment system account pass safety verification; and logging into the safe payment system account, and performing payment operations under the safe payment system account.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flowchart of a method for conducting online payment according to an exemplary embodiment.

FIG. 2 is a flowchart of another method for conducting online payment according to an exemplary embodiment.

FIG. 3 is block diagram of a device for conducting online payment according to an exemplary embodiment.

FIG. 4 is a block diagram of another device for conducting online payment according to an exemplary embodiment.

### DETAILED DESCRIPTION

In order to make objectives, technical solutions and advantages of the present disclosure more clear, embodiments of the present disclosure will be described in further detail with reference to drawings.

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

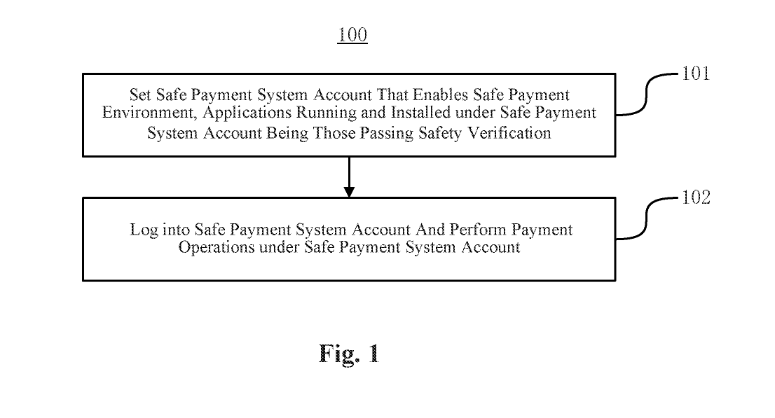

FIG. 1 is a flowchart of a method 100 for conducting an online payment according to an exemplary embodiment. The method 100 for conducting an online payment can be performed by a terminal, As shown in FIG. 1, the method 100 includes the following steps.

In step 101, a safe payment system account configured to enable a safe payment environment is set. Applications running and installed under the safe payment system account are those passing safety verification.

In step 102, the safe payment system account is logged into, and payment operations are performed under the safe payment system account.

In the method 100, a safe payment system account that enables a safe payment environment is set. Applications running and installed under the safe payment system account are those passing safety verification. The safe payment system account is logged into by a user, and payment operations are performed under the safe payment system account. That is, if an online payment needs to be performed on a terminal, the online payment has to be performed under the system managed by the safe payment system account. Because the applications running and installed under the safe payment system account are those passing safety verification, theft of user information by other application clients and property losses to users can be avoided during the online payment.

In one implementation of the present disclosure, the method 100 further includes: when detecting an operation for logging out the safe payment system account, removing user application data under the safe payment system account.

In a second implementation of the present disclosure, logging into the safe payment system account includes: when detecting a payment operation, determining whether a current system account is the safe payment system account; and if the current system account is not the safe payment system account, switching to the safe payment system account.

In a third implementation of the present disclosure, logging into the safe payment system account includes: receiving a log-in request for logging into the safe payment system account; and logging into the safe payment system account.

In a fourth implementation of the present disclosure, the method 100 further includes: under the safe payment system account, when receiving an installation request for installing an application, verifying whether a signature of the application is consistent with a signature of the application stored in an application authorization management system; if the signature of the application is consistent with the signature of the application in the application authorization management system, determining that installation of the application passes the safety verification, and installing the application under the safe payment system account in response to the installation request; and if the signature of the application is not consistent with the signature of the application in the application authorization management system, rejecting the installation request.

In a fifth implementation of the present disclosure, performing the payment operations under the safe payment system account includes: monitoring payment activities; if it is detected that there is data to be transmitted via a network during the payment, determining whether the to-be-transmitted data is allowed to be transmitted by the network according to a safety verification; if the to-be-transmitted data is allowed to be transmitted by the network according to the safety verification, allowing the to-be-transmitted data to be transmitted via the network and completing the payment operations; and if the to-be-transmitted data is prohibited from being accessed by the network according to the safety verification, discarding the to-be-transmitted data.

In a sixth implementation of the present disclosure, determining whether the to-be-transmitted data is allowed to be transmitted by the network according to the safety verification includes: according to a unique identifier (UID) of an application client corresponding to the transmitted data, detecting whether the to-be-transmitted data includes the UID; if the to-be-transmitted data includes the UID, determining that the to-be-transmitted data is allowed to be transmitted by the network according to the safety verification; and if the to-be-transmitted data does not include the UID, determining that the to-be-transmitted data is prohibited from being accessed by the network according to the safety verification.

In a seventh implementation of the present disclosure, the method 100 further includes: prohibiting all applications under the safe payment system account from reading short messages.

In an eighth implementation of the present disclosure, prohibiting all applications under the safe payment system account from reading short messages includes: restricting permissions for all of the applications to read the short messages by a system-provided permission management mechanism.

In a ninth implementation of the present disclosure, performing payment operations under the safe payment system account includes: transmitting data associated with the payment operations via a data network under the safe payment system account.

In a tenth implementation of the present disclosure, transmitting data associated with the payment operations via the data network under the safe payment system account includes: determining whether a currently-connected network is the data network; if the currently-connected network is the data network, transmitting the data associated with the payment operations via the data network; and if the currently-connected network is not the data network, displaying notification information to notify a user to connect to the data network, and transmitting the data associated with the payment operations via the data network after detecting that the current network is the data network.

All or part of the above technical solutions can be combined in any way to form other embodiments that are consistent with the present disclosure.

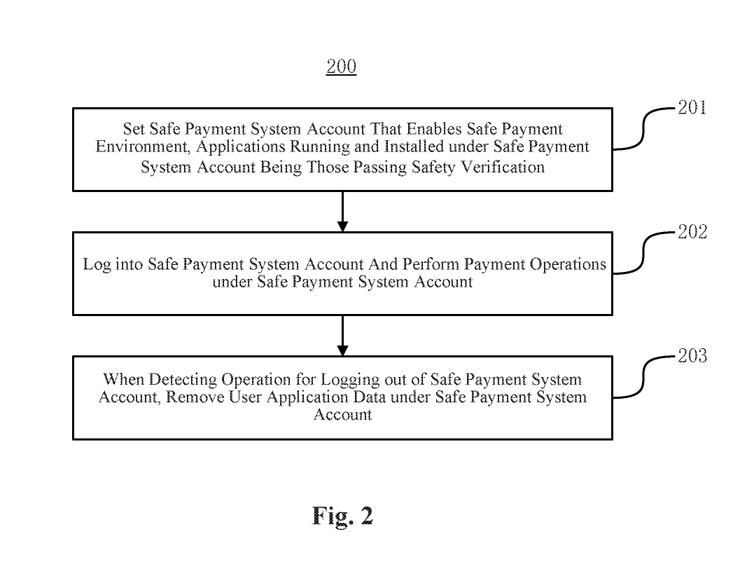

FIG. 2 is a flowchart of a method 200 for conducting an online payment according to an exemplary embodiment. The method 200 can be performed by a smart terminal such as a mobile phone. As shown in FIG. 2, the method 200 includes the following steps.

In step 201, a safe payment system account that enables a safe payment environment is set. Applications running and installed under the safe payment system account are those passing safety verification.

For example, a smart terminal may support multiple system accounts. One of the multiple system accounts can be set or designated as the account that is used exclusively for managing application clients having a payment function, so that online payment can be performed only under that system account. The smart terminal can use different system accounts to manage different systems. For example, a smart terminal, which supports multiple system accounts, has three system accounts: USER 1, USER 2, and USER 3, among which, USER 1 is used to manage office application clients in the system, USER 2 is used to manage application clients having the payment function in the system, and USER 3 is used to manage application clients for entertainment. The account USER 2 can be a preset system account in the smart terminal for managing the application clients having the payment function.

In another embodiment of the present disclosure, when an installation request for installing an application under the safe payment system account is received, whether a signature of the application is consistent with a signature of the application in an application authorization management system is verified. If the signature of the application is consistent with the signature of the application in the application authorization management system, it is determined that the application passes the safety verification, and the application is installed under the safe payment system account in response to the installation request; if the signature of the application is not consistent with the signature of the application in the application authorization management system, the installation request is rejected. The application authorization management system is used to store identifications of application clients having a safe payment function and the signature corresponding to each of the application clients. An identification of each application client can be a name of the application client, or a UID of the application, or other information which can uniquely identify the application client. Embodiments of the present disclosure do not impose specific limitations on this. The signature of each application client is used to represent the uniqueness of the application client.

Checking whether the signature of the application client is consistent with a signature of the application client in a designated server can avoid situations where unauthorized application clients obfuscate or replace already-installed reliable application clients to steal user data.

In step 202, the safe payment system account is logged into, and payment operations are performed under the safe payment system account.

The safe payment system account can be logged into as follows. A smart terminal can receive a log-in request for logging into the safe payment system account. The log-in request for logging into the safe payment system account can be triggered by the following methods. For example, on a system switching interface, when a triggering operation on the account name of the safe payment system account is detected, the log-in request for logging into the safe payment system account is triggered. As another example, if the terminal has a touch screen, a designated gesture can be used to trigger the log-in request for logging into the safe payment system account. Other methods can be used to trigger a log-in operation for the safe payment system account. Embodiments of the present disclosure do not impose specific limitations on this.

In one embodiment, the system under which the terminal is currently running is the safe payment system account. When a payment operation is detected, the payment operation can be finished according to a payment process. If the system under which the terminal is currently running is not the safe payment system account, the payment operation cannot be conducted. Before the payment, the terminal is configured to detect whether the system under which the terminal currently running is the safe payment system account. To do this, the following steps can be performed: when detecting a payment operation, determining whether a current system account is the safe payment system account; and if the current system account is not the safe payment system account, switching to the safe payment system account.

Any one of the application clients under the safe payment system account is an application client having a payment function. After a starting operation for any one application client under the safe payment system account is detected, it can be determined that a user wants to conduct payment online. The starting operation on the application client can be the user's tapping or touch operation or other types of triggering operation on the application client. Embodiments of the present disclosure do not impose specific limitations on this.

In another embodiment of the present disclosure, if the system under which the terminal is currently running is not the safe payment system account, notification information can be displayed on the screen of the terminal to notify the user to perform a switching operation to the safe payment system account. Options for switching and not switching can be displayed, so that the user can determine whether to switch to the preset safe payment system account or not. Other manners can be used to notify the user and embodiments of the present disclosure do not impose specific limitations on this. Whether to perform notification can be set by users by means of a system setting option so as to satisfy needs of different users.

Whether the current system account is the safe payment system account is checked to determine whether to perform the switching operation. In one embodiment, if an online payment needs to be performed on a current terminal, the online payment has to be performed under the system managed by the safe payment system account. Because the applications running and installed under the safe payment system account are those passing safety verification, theft of user information by other application clients and property losses to users can be avoided during the online payment.

According to another embodiment of the present disclosure, during the payment procedure, payment activities are monitored. If it is detected that there is data to be transmitted via a network during the payment, whether the to-be-transmitted data is allowed to be transmitted by the network according to a safety verification is determined. If the to-be-transmitted data is allowed to be transmitted by the network according to the safety verification, the to-be-transmitted data is allowed to be transmitted via the network and the payment operation is completed. If the to-be-transmitted data is prohibited from being accessed by the network according to the safety verification, the to-be-transmitted data is discarded. The network-based data transmission is included in the payment procedure, which includes a procedure for the terminal to receive the data from a server and a procedure for the terminal to send data to the server. For example, before the online payment, the server sends verification information to the terminal, and the terminal sends information such as the amount to be paid, the account information of the person receiving the payment, and the user information registered in the client currently used for the payment.

In one embodiment, determining whether the to-be-transmitted data is allowed to be transmitted by the network according to the safety verification includes: according to a UID of an application client corresponding to the to-be-transmitted data, detecting whether the to-be-transmitted data includes the UID; if the to-be-transmitted data includes the UID, determining that the to-be-transmitted data is allowed to be transmitted by the network according to the safety verification; and if the to-be-transmitted data does not include the UID, determining that the to-be-transmitted data is prohibited from being accessed by the network according to the safety verification. Other methods may be employed to determine whether the to-be-transmitted data is allowed to be transmitted by the network according to the safety verification. For example, other types of data can be used which can identify the uniqueness of corresponding application clients. Embodiments of the present disclosure do not impose specific limitations on the data used for the determination.

The determination of whether the to-be-transmitted data includes the UID according to the UID of the application client corresponding to the to-be-transmitted data can be realized as follows. In an IP information packet filtering system, UIDs of all application clients having the payment function managed by the safe payment system account are listed in, for example, a table (IP Table). The IP Table includes the UID of the application client which is currently running, i.e., the application client which is currently performing the online payment. Each piece of to-be-transmitted data is monitored. The data that does not include the UID of the application client that is currently running is determined as the data which is prohibited from being accessed by the network according to the safety verification. The data that includes the UID of the application client that is currently running is determined as the data which is allowed to be transmitted by the network according to the safety verification.

In another embodiment of the present disclosure, if the to-be-transmitted data does not include the UID and the to-be-transmitted data is determined as the data which is prohibited from being accessed by the network according to the safety verification, the to-be-transmitted data is discarded. That is, only the application client which is currently used for the online payment has the permission to access the network. Other application clients do not have the network-access permission. By the above methods, sending data carrying user information to an unauthorized server, which may result in breach of user privacy, can be avoided. Accordingly, the safety of the online payment can be further improved.

In another embodiment of the present disclosure, under the safe payment system account, all the applications are prohibited from reading short messages. For example, permissions for all of the applications under the safe payment system account to read the short messages can be restricted by a system-provided permission management mechanism. The permission management mechanism is used to manage the permissions for application clients installed in the smart terminal, The permissions determine whether the application clients can use system functions.

In one embodiment, restricting permissions for all of the applications to read the short messages by the system-provided permission management mechanism can be implemented as follows: on a system permission setting interface under the safe payment system account, identification information of all application clients are deleted from a list in which application clients having the permission to read short messages are listed.

Other methods can be used to prohibit all applications under the safe payment system account from reading short messages. Embodiments of the present disclosure do not impose specific limitations on this.

During the online payment, servers may send verification codes to terminals by short messages. By prohibiting all applications managed by the safe payment system account from reading contents of the short messages, theft of the verification codes in the short messages by unauthorized application clients and theft of user data can be avoided. Accordingly, property losses to users can be avoided.

In another embodiment of the present disclosure, under the safe payment system account, data associated with the payment operations is transmitted via a data network. Specifically, whether a currently-connected network is a data network is determined. If the currently-connected network is the data network, the data associated with the payment operations is transmitted via the data network. If the currently-connected network is not the data network, notification information is displayed to notify a user to connect to the data network. As a result, the data associated with the payment operations is transmitted via the data network after detecting that the current network is the data network.

For example, detection of whether the currently-connected network is the data network can be performed by detecting the Internet Protocol address of the smart terminal, or other methods. Embodiments of the present disclosure do not impose specific limitations on this.

Transmission of data associated with the payment operations is performed via a data network only if the network which the terminal is currently-connected to is the data network. This can prevent unauthorized individuals from stealing user data via falsified WiFi, and property losses to users can be avoided. Consequently, safety of online payment can be improved.

In step 203, when an operation for logging out the safe payment system account is detected, user application data under the safe payment system account is removed or cleared.

The operation for logging out of the safe payment system account includes operations for switching to other system account or shutting down the safe payment system account. Other operations for logging out can be included and embodiments of the present disclosure do not impose specific limitations on this. During the period when the safe payment system account is logged in, the application data generated by the application clients having the payment function includes, at least, data sent to corresponding servers during the online payment, data returned by the servers, or information about log-in accounts, or other data. Embodiments of the present disclosure do not impose specific limitations on this.

Upon detection of the operation of logging out of the safe payment system account, application data generated by the application clients having the payment function during the period when the safe payment system account is logged into is removed or cleared. This can reduce the probability of theft of user data and thereby improve the safety of online payment.

In the illustrated methods, a safe payment system account that enables a safe payment environment is set. Applications running and installed under the safe payment system account are those passing safety verification. The safe payment system account is logged into, and a payment operation is performed under the safe payment system account. That is, if an online payment needs to be performed on a current terminal, it is performed under the system managed by the safe payment system account. Because the applications running and installed under the safe payment system account are those passing safety verification, theft of user information by other application clients and property losses to users can be avoided or reduced during the online payment. Further, whether the currently-connected network is a data network is detected, so that transmission of data associated with the payment operations is performed via a data network only if the network which the terminal is currently-connected to is the data network. This can prevent unauthorized individuals from stealing user data via falsified WiFi so that property losses to users can be avoided. Consequently, safety of online payment can be improved.

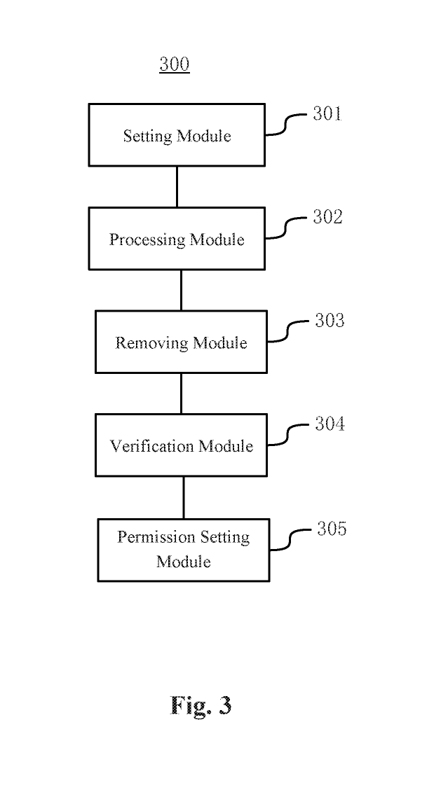

FIG. 3 is a block diagram of a device 300 for conducting online payment according to an exemplary embodiment. Referring to FIG. 3, the device 300 includes a setting module 301 and a processing module 302.

The setting module 301 is configured to set a safe payment system account that enables a safe payment environment. Applications running and installed under the safe payment system account are those passing safety verification.

The processing module 302 is configured to log into the safe payment system account and perform payment operations under the safe payment system account.

In a first possible implementation of the present disclosure, the device further includes: a removing module 303 configured to, when an operation for logging out of the safe payment system account is detected, remove user application data under the safe payment system account.

In some embodiments, the processing module 302 is further configured to: when detecting a payment operation, determine whether a current system account is the safe payment system account; and if the current system account is not the safe payment system account, switch to the safe payment system account.

In some embodiments, the processing module 302 further is configured to: receive a log-in request for logging into the safe payment system account; and log into the safe payment system account.

In some embodiments, the device 300 further includes: a verification module 304 configured to, under the safe payment system account, when receiving an installation request for installing an application, verify whether a signature of the application is consistent with a signature of the application stored in an application authorization management system; if the signature of the application is consistent with the signature of the application in the application authorization management system, determine that installation of the application passes the safety verification, and install the application under the safe payment system account in response to the installation request; and if the signature of the application is not consistent with the signature of the application in the application authorization management system, reject the installation request.

In some embodiments, the processing module 302 is further configured to: monitor payment activities; if it is detected that there is data to be transmitted via a network during the payment, determine whether the to-be-transmitted data is allowed to be transmitted by the network according to a safety verification; if the to-be-transmitted data is allowed to be transmitted by the network according to the safety verification, allow the to-be-transmitted data to be transmitted via the network and complete the payment operations; and if the to-be-transmitted data is prohibited from being accessed by the network according to the safety verification, discard the to-be-transmitted data.

In some embodiments, the processing module 302 is further configured to: according to a UID of an application client corresponding to the to-be-transmitted data, detect whether the to-be-transmitted data includes the UID; if the to-be-transmitted data includes the UID, determine that the to-be-transmitted data is allowed to be transmitted by the network according to the safety verification; and if the to-be-transmitted data does not include the UID, determine that the to-be-transmitted data is prohibited from being accessed by the network according to the safety verification.

In some embodiments, the device 300 further includes a permission setting module 305 configured to prohibit all applications under the safe payment system account from reading short messages.

In some embodiments, the permission setting module 305 is further configured to restrict permissions for all of the applications to read the short messages by a system-provided permission management mechanism.

In some embodiments, the processing module 302 is further configured to, under the safe payment system account, transmit data associated with the payment operations via a data network.

In some embodiments, the processing module 302 is further configured to: determine whether a currently-connected network is the data network; if the currently-connected network is the data network, transmit the data associated with the payment operations via the data network; and if the currently-connected network is not the data network, display notification information to notify a user to connect to the data network, and transmit the data associated with the payment operations via the data network after detecting that the current network is the data network.

With respect to the devices in the above embodiments, the specific manners for performing operations for individual modules therein have been described in detail in the embodiments regarding the methods, which will not be further elaborated.

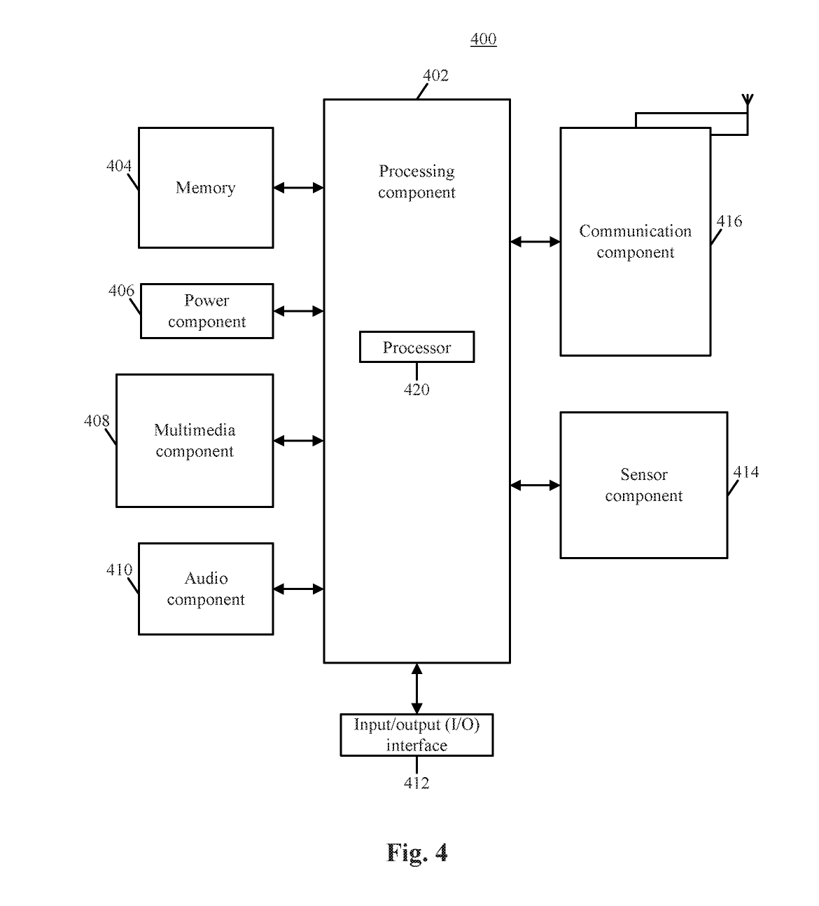

FIG. 4 is a block diagram of a device 400 for conducting online payment according to an exemplary embodiment. For example, the device 400 may be a mobile phone, a computer, a digital broadcast terminal, a messaging device, a gaming console, a tablet, a medical device, exercise equipment, a personal digital assistant, and the like.

Referring to FIG. 4, the device 400 includes one or more of the following components: a processing component 402, a memory 404, a power component 406, a multimedia component 408, an audio component 410, an input/output (I/O) interface 412, a sensor component 414, and a communication component 416.

The processing component 402 typically controls overall operations of the device 400, such as the operations associated with display, telephone calls, data communications, camera operations, and recording operations. The processing component 402 may include one or more processors 420 to execute instructions to perform all or part of the steps in the above described methods. Moreover, the processing component 402 may include one or more modules which facilitate the interaction between the processing component 402 and other components. For instance, the processing component 402 may include a multimedia module to facilitate the interaction between the multimedia component 408 and the processing component 402.

The memory 404 is configured to store various types of data to support the operation of the device 400. Examples of such data include instructions for any applications or methods operated on the device 400, contact data, phonebook data, messages, pictures, video, etc. The memory 404 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 406 provides power to various components of the device 400. The power component 406 may include a power management system, one or more power sources, and any other components associated with the generation, management, and distribution of power in the device 400.

The multimedia component 408 includes a screen providing an output interface between the device 400 and the user. In some embodiments, the screen may include a liquid crystal display and a touch panel. If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 408 includes a front camera and/or a rear camera. The front camera and the rear camera may receive an external multimedia datum while the device 400 is in an operation mode, such as a photographing mode or a video mode. Each of the front camera and the rear camera may be a fixed optical lens system or have focus and optical zoom capability.

The audio component 410 is configured to output and/or input audio signals. For example, the audio component 410 includes a microphone configured to receive an external audio signal when the device 400 is in an operation mode, such as a call mode, a recording mode, and a voice recognition mode. The received audio signal may be further stored in the memory 404 or transmitted via the communication component 416. In some embodiments, the audio component 410 further includes a speaker to output audio signals.

The I/O interface 412 provides an interface between the processing component 402 and peripheral interface modules, such as a keyboard, a click wheel, buttons, and the like. The buttons may include, but are not limited to, a home button, a volume button, a starting button, and a locking button.

The sensor component 414 includes one or more sensors to provide status assessments of various aspects of the device 400. For instance, the sensor component 414 may detect an open/closed status of the device 400, relative positioning of components, e.g., the display and the keypad, of the device 400, a change in position of the device 400 or a component of the device 400, a presence or absence of user contact with the device 400, an orientation or an acceleration/deceleration of the device 400, and a change in temperature of the device 400. The sensor component 414 may include a proximity sensor configured to detect the presence of nearby objects without any physical contact. The sensor component 414 may also include a light sensor, such as a CMOS or CCD image sensor, for use in imaging applications. In some embodiments, the sensor component 414 may also include an accelerometer sensor, a gyroscope sensor, a magnetic sensor, a pressure sensor, or a temperature sensor.

The communication component 416 is configured to facilitate communication, wired or wirelessly, between the device 400 and other devices. The device 400 can access a wireless network based on a communication standard, such as WiFi, 2G, 3G or 4G or a combination thereof. In one exemplary embodiment, the communication component 416 receives a broadcast signal or broadcast associated information from an external broadcast management system via a broadcast channel. In one exemplary embodiment, the communication component 416 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 400 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods for online payment.

In exemplary embodiments, there is also provided a non-transitory computer-readable storage medium including instructions, such as the memory 404 including instructions executable by the processor 420 in the device 400, for performing the above-described methods. For example, the non-transitory computer-readable storage medium may be a ROM, a RAM, a CD-ROM, a magnetic tape, a floppy disc, an optical data storage device, and the like.

In exemplary embodiments, there is also provided a non-transitory computer-readable storage medium having stored therein instructions that, when executed by a processor of a mobile terminal, causes the mobile terminal to perform above methods for online payment.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for online payment, comprising:
setting a safe payment system account that enables a safe payment environment, wherein applications running and installed under the safe payment system account pass safety verification; and
logging into the safe payment system account, and performing payment operations under the safe payment system account.

2. The method according to claim 1, further comprising:
when detecting an operation for logging out the safe payment system account, removing user application data under the safe payment system account.

3. The method according to claim 1, wherein the logging into the safe payment system account comprises:
when detecting a payment operation, determining whether a current system account is the safe payment system account; and
if the current system account is not the safe payment system account, switching to the safe payment system account.

4. The method according to claim 1, wherein the logging into the safe payment system account comprises:
receiving a log-in request for logging into the safe payment system account; and
logging into the safe payment system account.

5. The method according to claim 1, further comprising:
under the safe payment system account, when receiving an installation request for installing an application, verifying whether a signature of the application is consistent with a signature of the application in an application authorization management system;
if the signature of the application is consistent with the signature of the application in the application authorization management system, determining that installation of the application passes the safety verification, and installing the application under the safe payment system account in response to the installation request; and
if the signature of the application is not consistent with the signature of the application in the application authorization management system, rejecting the installation request.

6. The method according to claim 1, wherein the performing the payment operations under the safe payment system account comprises:
monitoring payment activities;
if it is detected that there is data to be transmitted via a network during the payment, determining whether the to-be-transmitted data is allowed to be transmitted via the network according to a safety verification;
if the to-be-transmitted data is allowed to be transmitted by the network according to the safety verification, allowing the to-be-transmitted data to be transmitted via the network and completing the payment operations; and
if the to-be-transmitted data is prohibited from being accessed by the network according to the safety verification, discarding the to-be-transmitted data.

7. The method according to claim 6, wherein the determining whether the to-be-transmitted data is allowed to be transmitted by the network according to the safety verification comprises:
according to a unique identifier (UID) of an application client corresponding to the to-be-transmitted data, detecting whether the to-be-transmitted data includes the UID;
if the to-be-transmitted data includes the UID, determining that the to-be-transmitted data is allowed to be transmitted by the network according to the safety verification; and
if the to-be-transmitted data does not include the UID, determining that the to-be-transmitted data is prohibited from being accessed by the network according to the safety verification.

8. The method according to claim 1, further comprising:
prohibiting all applications under the safe payment system account from reading short messages.

9. The method according to claim 8, wherein the prohibiting all applications under the safe payment system account from reading short messages comprises:
restricting permissions for all of the applications to read the short messages by a system-provided permission management mechanism.

10. The method according to claim 1, wherein the performing payment operations under the safe payment system account comprises:
under the safe payment system account, transmitting data associated with the payment operations via a data network.

11. The method according to claim 10, wherein the transmitting data associated with the payment operations via the data network under the safe payment system account comprises:
determining whether a currently-connected network is the data network;
if the currently-connected network is the data network, transmitting the data associated with the payment operations via the data network; and
if the currently-connected network is not the data network, displaying notification information to notify a user to connect to the data network, and transmitting the data associated with the payment operations via the data network after detecting that the current network is the data network.

12. A device for online payment, comprising:
a processor; and
a memory for storing instructions executable by the processor,
wherein the processor is configured to:
set a safe payment system account that enables a safe payment environment, wherein applications running and installed under the safe payment system account pass safety verification; and
log into the safe payment system account, and perform payment operations under the safe payment system account.

13. The device according to claim 12, wherein the processor is further configured to:
when detecting an operation for logging out the safe payment system account, remove user application data under the safe payment system account.

14. The device according to claim 12, wherein the processor is configured to:
when detecting a payment operation, determine whether a current system account is the safe payment system account; and
if the current system account is not the safe payment system account, switch to the safe payment system account.

15. The device according to claim 12, wherein the processor is further configured to:
under the safe payment system account, when receiving an installation request for installing an application, verify whether a signature of the application is consistent with a signature of the application in an application authorization management system;
if the signature of the application is consistent with the signature of the application in the application authorization management system, determine that installation of the application passes the safety verification, and install the application under the safe payment system account in response to the installation request; and
if the signature of the application is not consistent with the signature of the application in the application authorization management system, reject the installation request.

16. The device according to claim 12, wherein the processor is configured to:
monitor payment activities;
if it is detected that there is data to be transmitted via a network during the payment, determine whether the to-be-transmitted data is allowed to be transmitted via the network according to a safety verification;
if the to-be-transmitted data is allowed to be transmitted by the network according to the safety verification, allow the to-be-transmitted data to be transmitted via the network and completing the payment operations; and
if the to-be-transmitted data is prohibited from being accessed by the network according to the safety verification, discard the to-be-transmitted data.

17. The device according to claim 16, wherein the processor is configured to:
according to a unique identifier (UID) of an application client corresponding to the to-be-transmitted data, detect whether the to-be-transmitted data includes the UID;
if the to-be-transmitted data includes the UID, determine that the to-be-transmitted data is allowed to be transmitted by the network according to the safety verification; and
if the to-be-transmitted data does not include the UID, determine that the to-be-transmitted data is prohibited from being accessed by the network according to the safety verification.

18. The device according to claim 12, wherein the processor is further configured to:
prohibit all applications under the safe payment system account from reading short messages.

19. The device according to claim 12, wherein the processor is configured to:
under the safe payment system account, transmit data associated with the payment operations via a data network.

20. A non-transitory computer-readable storage medium having stored therein instructions that, when executed by a processor of a smart terminal, causes the smart terminal to perform a method for conducting an online payment, the method comprising:
setting a safe payment system account that enables a safe payment environment, wherein applications running and installed under the safe payment system account pass safety verification; and
logging into the safe payment system account, and performing payment operations under the safe payment system account.
